(19) United States
(12) Patent Application Publication
(10) Pub. No.: US 2008/0278647 A1
(43) Pub. Date: Nov. 13, 2008

(54) LIQUID CRYSTAL DISPLAY DEVICE AND METHOD OF DRIVING LIQUID CRYSTAL DISPLAY DEVICE

(76) Inventors: Tetsuo FUKAMI, Ishikawa-gun (JP); Yukio Tanaka, Kanazawa-shi (JP); Kenji Nakao, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/113,401

(22) Filed: May 1, 2008

(30) Foreign Application Priority Data
May 7, 2007 (JP) 2007-122481

(51) Int. Cl. G02F 1/133

(52) U.S. Cl. 349/39

(57) ABSTRACT

A liquid crystal display device includes substrates which are opposed to each other, a liquid crystal layer which includes an OCB mode liquid crystal and is held between the substrates, a display section which is composed of display pixels that are arrayed in a matrix, and a driving unit which cyclically charges a reverse transition prevention signal and a video signal in each of the display pixels. The driving unit includes circuits for varying a liquid crystal voltage which is retained in the display pixel after the charging of the reverse transition prevention signal, and a liquid crystal voltage which is retained in the display pixel after the charging of the video signal, thereby making a variation amount of the liquid crystal voltage after the charging of the reverse transition prevention signal greater than a variation amount of the liquid crystal voltage after the charging of the video signal.

### CROSS-REFERENCE TO RELATED APPLICATIONS

This application is based upon and claims the benefit of priority from prior Japanese Patent Application No. 2007-122481, filed May 7, 2007, the entire contents of which are incorporated herein by reference.

### BACKGROUND OF THE INVENTION

1. Field of the Invention

The present invention relates generally to a liquid crystal display device and a method of driving the liquid crystal display device, and more particularly to an active matrix liquid crystal display device and a method of driving the active matrix liquid crystal display device.

2. Description of the Related Art

Compared to, for instance, a TN mode liquid crystal display device, an OCB (Optically Compensated Bend) mode liquid crystal display device has features of higher responsivity and a larger viewing angle. By virtue of these features, the OCB mode liquid crystal display device is most suitable for liquid crystal TV products, the market of which is expected to grow more and more in the future.

In the OCB mode liquid crystal display device, however, driving methods are needed for changing (“transitioning”) a splay alignment, which is an alignment state of liquid crystal molecules in a power-off state, to a bend alignment which is an alignment state of liquid crystal molecules in a power-on state, and for preventing a change (“reverse transition”) of the alignment state from the bend alignment to the splay alignment.

The reverse transition phenomenon of the OCB mode liquid crystal occurs when a liquid crystal voltage of a predetermined voltage (Vc) or more is not applied over a predetermined time or more. Conventionally, it has been proposed to execute black insertion driving in order to prevent the reverse transition phenomenon in the liquid crystal display device using the OCB mode liquid crystal (see Jpn. Pat. Appln. KOKAI Publication No. 2003-29303).

As the value of the voltage (“reverse transition prevention voltage”) that is applied to prevent the reverse transition of the liquid crystal becomes higher, and as the time for applying this voltage becomes longer, the stability of the bend alignment state is more improved.

As regards the transmittance versus voltage characteristics (T-V characteristics) of the OCB mode liquid crystal, the voltage (corresponding to black display) is uniquely determined depending on the liquid crystal material, cell condition, etc. Thus, when the reverse voltage prevention voltage is set at a value that is high enough to prevent reverse transition, this value may become, in some cases, higher than the voltage corresponding to black display. In such cases, the transmittance at the time of applying the reverse transition prevention voltage cannot sufficiently be lowered, and it is difficult to prevent a decrease in contrast.

On the other hand, if reverse transition prevention is executed by applying the voltage corresponding to black display in order to obtain the effect of the improvement in visibility, the following problem may occur. That is, if a sufficient time for applying the reverse transition prevention voltage is to be secured in order to prevent reverse transition, the time/aperture ratio is restricted by the black insertion voltage, and a decrease in luminance may occur in some cases.

### BRIEF SUMMARY OF THE INVENTION

The present invention has been made in consideration of the above-described problem, and the object of the invention is to provide a liquid crystal display device which can prevent a decrease in contrast and luminance and has a high display quality, and a method of driving the liquid crystal display device.

According to a first aspect of the present invention, there is provided a liquid crystal display device comprising: a first substrate and a second substrate which are opposed to each other; a liquid crystal layer which includes an OCB mode liquid crystal and is held between the first substrate and the second substrate; a display section which is composed of a plurality of display pixels that are arrayed in a matrix; and a driving unit which cyclically charges a reverse transition prevention signal and a video signal in each of the display pixels, wherein the driving unit includes means for varying a liquid crystal voltage which is retained in the display pixel after the charging of the reverse transition prevention signal, and a liquid crystal voltage which is retained in the display pixel after the charging of the video signal, thereby making a variation amount of the liquid crystal voltage after the charging of the reverse transition prevention signal greater than a variation amount of the liquid crystal voltage after the charging of the video signal.

According to a second aspect of the present invention, there is provided a method of driving a liquid crystal display device comprising: a first substrate and a second substrate which are opposed to each other; a liquid crystal layer which is held between the first substrate and the second substrate and includes an OCB mode liquid crystal; a display section which is composed of a plurality of display pixels that are arrayed in a matrix; and a driving unit which cyclically applies a reverse transition prevention signal and a video signal to each of the plurality of display pixels, the method comprising: a step of cyclically charging the reverse transition prevention signal and the video signal in each of the plurality of display pixels; and a step of varying a liquid crystal voltage which is retained in the display pixel after the charging of the reverse transition prevention signal, and a liquid crystal voltage which is retained in the display pixel after the charging of the video signal, and making a variation amount of the liquid crystal voltage after the charging of the reverse transition prevention signal greater than a variation amount of the liquid crystal voltage after the charging of the video signal.

The present invention can provide a liquid crystal display device which can prevent a decrease in contrast and luminance and has a high display quality, and a method of driving the liquid crystal display device.

Additional objects and advantages of the invention will be set forth in the description which follows, and in part will be obvious from the description, or may be learned by practice of the invention. The objects and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows an example of the structure of a liquid crystal display device according to a first embodiment of the present invention;

FIG. 2 schematically shows an example of the structure of a display pixel of the liquid crystal display device shown in FIG. 1;

FIG. 3 is a view for explaining an example of a driving method of the liquid crystal display device shown in FIG. 1;

FIG. 4 schematically shows an example of transmittance versus voltage characteristics of an OCB mode liquid crystal; and

FIG. 5 schematically shows an example of the structure of a liquid crystal display device according to a second embodiment of the invention.

### DETAILED DESCRIPTION OF THE INVENTION

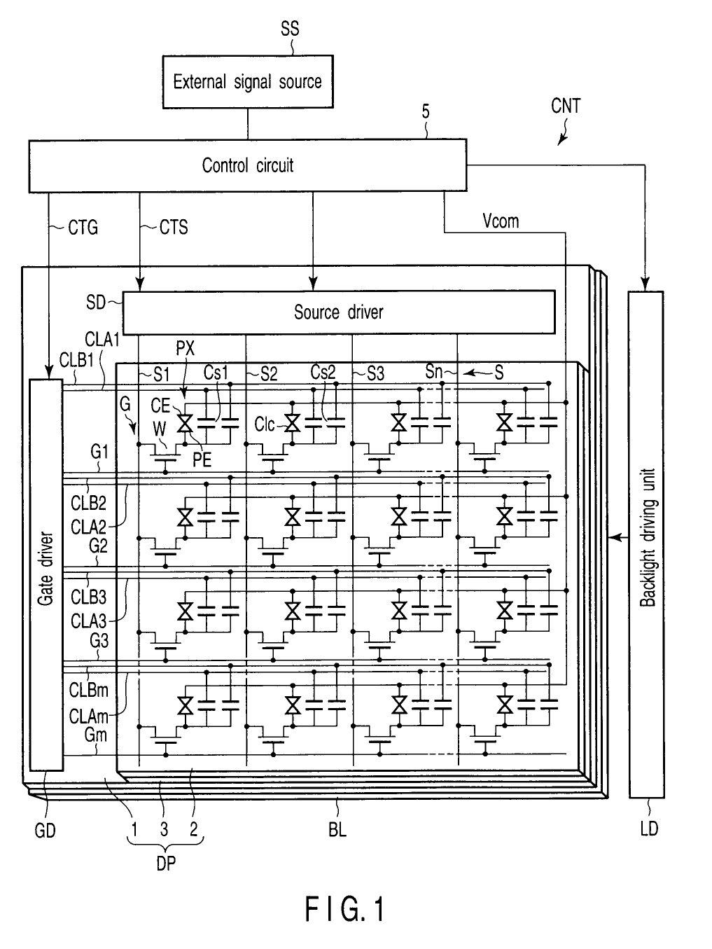

A liquid crystal display device according to a first embodiment of the present invention will now be described with reference to the accompanying drawings. As shown in FIG. 1, the liquid crystal display device according to this embodiment includes an OCB mode liquid crystal display panel DP, a backlight BL which illuminates the liquid crystal display panel DP, and a controller CNT which controls the liquid crystal display panel DP and backlight BL.

The liquid crystal display panel DP includes a pair of electrode substrates, i.e. an array substrate 1 and a counter-substrate 2, and a liquid crystal layer 3 which is held between the array substrate 1 and counter-substrate 2. The liquid crystal layer 3 includes, as a liquid crystal material, an OCB mode liquid crystal which is transitioned in advance, for example, from a splay alignment to a bend alignment in order to execute a normally-white display operation.

In this embodiment, reverse transition of the liquid crystal from the bend alignment to splay alignment is prevented by cyclically applying a reverse transition prevention signal Vb to the liquid crystal layer 3.

The liquid crystal display panel DP includes a display section which is composed of display pixels PX that are arrayed substantially in a matrix. The array substrate 1 includes a transparent insulating substrate which is formed of, e.g. glass. A plurality of pixel electrodes PE are disposed in association with the respective display pixels PX on the transparent insulating substrate.

Further, the array substrate 1 includes a plurality of scanning lines G (G1 to Gm) which are disposed along rows of the pixel electrodes PE, a plurality of signal lines S (S1 to Sn) which are disposed along columns of the pixel electrodes PE, and first storage capacitance lines CLA (CLA1 to CLAm) and second storage capacitance lines CLB (CLB1 to CLBm) which are disposed substantially in parallel to the scanning lines G.

A plurality of pixel switches W are disposed near intersections between the scanning lines G and signal lines S and permit, when driven via the associated scanning lines G, electrical conduction between the associated signal lines S and the associated pixel electrodes PE.

Each of the pixel switches W is composed of, e.g. a thin-film transistor. The gate of the pixel switch W is connected to the scanning line G, and the source-drain path of the pixel switch W is connected between the signal line S and the pixel electrode PE.

The counter-substrate 2 includes a color filter (not shown) which is formed of red, green and blue color layers disposed on a transparent insulating substrate of, e.g. glass, and a counter-electrode CE which is disposed on the color filter and is opposed to the plural pixel electrodes PE.

The pixel electrodes PE and counter-electrode CE are formed of a transparent electrode material such as ITO and are covered with a pair of alignment films (not shown), respectively, which are subjected to rubbing treatment in mutually parallel directions.

Each pixel electrode PE and counter-electrode CE, together with a pixel region which is a part of the liquid crystal layer 3 that is controlled to have a liquid crystal molecular alignment corresponding to an electric field from the pixel electrode PE and counter-electrode CE, constitute the display pixel PX.

Each of the display pixels PX has a liquid crystal capacitance Clc between the associated pixel electrode PE and counter-electrode CE. The magnitude of the liquid crystal capacitance Clc is determined by, for example, a specific dielectric constant of the liquid crystal material, a pixel electrode area and a liquid crystal cell gap.

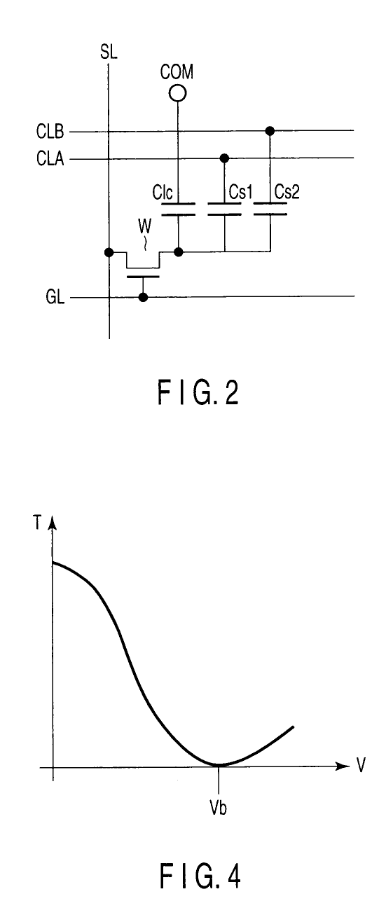

Furthermore, as shown in FIG. 1 and FIG. 2, the liquid crystal display device according to the present embodiment includes, in each of the display pixels PX, a first storage capacitance Cs1 which is produced by a voltage that is applied to the pixel electrode PE and a voltage that is applied to the first storage capacitance line CLA, and a second storage capacitance Cs2 which is produced by a voltage that is applied to the pixel electrode PE and a voltage that is applied to the second storage capacitance line CLB.

The controller CNT includes, as driving units, a source driver SD to which the signal lines S are connected; a gate driver GD to which the scanning lines G, first storage capacitance lines CLA and second capacitance lines CLB are connected; a backlight driving unit LD which drives the backlight BL; and a control circuit 5 which controls the gate driver GD, source driver SD and backlight driving unit (inverter) LD.

The gate driver GD successively drives the scanning lines G1 to Gm so as to turn on plural pixel switches W on a row-by-row basis, and successively drives plural first storage capacitance lines CLA and second storage capacitance lines CLB so that the voltages of the first storage capacitance lines CLA and second storage capacitance lines CLB may vary on a row-by-row basis. The source driver SD outputs source signals Vs to the plural signal lines S1 to Sn in a time period in which the pixel switches W of each row are turned on by the driving of the associated scanning line G.

The control circuit 5 is configured to execute an initializing process for transitioning liquid crystal molecules from a splay alignment to a bend alignment by varying a counter-voltage Vcom at a time of power-on and applying a relatively high driving voltage to the liquid crystal layer 3.

The control circuit 5 outputs to the gate driver GD a control signal CTG which is generated on the basis of a sync signal that is input from an external signal source SS. The control circuit 5 also outputs to the source driver SD a control signal CTS which is generated on the basis of the sync signal that is input from the external signal source SS, and a video signal Vp or a reverse transition prevention voltage Vb, which is input from the external signal source SS. Further, the control circuit 5 outputs a counter-voltage Vcom, which is to be applied to the counter-electrode CE, to the counter-electrode CE of the counter-substrate CT.

In the control circuit 5, a reverse transition prevention signal charging period and a video signal charging period are set on the basis of the sync signal that is input from the external signal source SS. The reverse transition prevention signal charging period is used in order to execute write of the reverse transition prevention voltage Vb in the plural display pixels PX. The video signal charging period is used in order to execute write of the video signal Vp in the plural display pixels PX. The reverse transition prevention signal charging period and the video signal charging period are so set as to be cyclically repeated by the control circuit 5.

Next, the operation of the above-described liquid crystal display device is described with reference to the accompanying drawings. The pixel switch W, which is disposed in each display pixel PX, is rendered conductive in a time period in which a voltage that is applied to the scanning line G is an on-voltage Vgon, and the source signal Vs that is applied to the source line S is charged in the pixel electrode PE during this period.

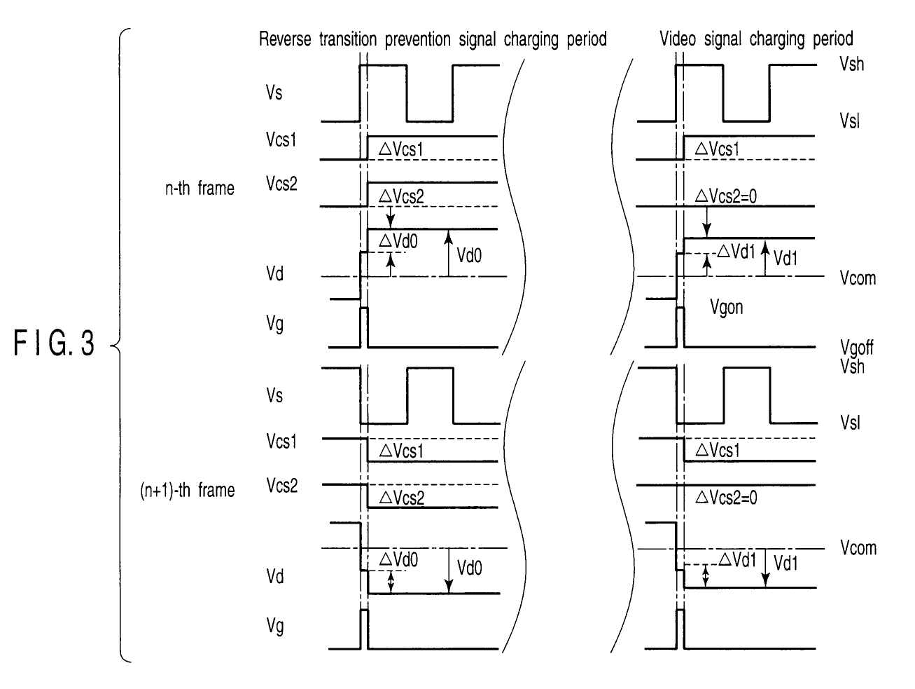

For example, in an n-th frame shown in FIG. 3, a high level voltage Vsh is charged as the source signal Vs in the pixel electrode PE of the display pixel PX in each of the reverse transition prevention signal charging period and the video signal charging period. Specifically, in the n-th frame shown in FIG. 3, the high level voltage Vsh is charged in the pixel electrode PE as the reverse transition prevention voltage Vb and the video signal Vp.

In an (n+1)-th frame shown in FIG. 3, a low level voltage Vs1 is charged as the source signal Vs in the pixel electrode PE in each of the reverse transition prevention signal charging period and the video signal charging period. Specifically, in the (n+1)-th frame shown in FIG. 3, the low level voltage Vs1 is charged in the pixel electrode PE as the reverse transition prevention voltage Vb and the video signal Vp.

In each of the reverse transition prevention signal charging period and the video signal charging period, after the source signal Vs is charged in the pixel electrode PE, the gate signal Vg that is applied to the gate line G is set at an off-voltage Vgoff. Thereby, the pixel switch W is rendered non-conductive, and the source voltage Vs that is charged in the pixel electrode PE is retained.

In the liquid crystal display device according to the present embodiment, the reverse transition prevention signal Vb or the video signal Vp is written in the pixel electrode PE, and after the pixel switch W is turned off, the potentials of the first storage capacitance line CLA and second storage capacitance line CLB are varied.

Specifically, the control circuit 5 controls the gate driver GD to vary storage capacitance voltages Vcs1 and Vcs2 which are applied to the first storage capacitance Cs1 and second storage capacitance Cs2, thereby varying the magnitude of the liquid crystal voltage Vd after the charging of the reverse transition prevention signal Vb and the magnitude of the liquid crystal voltage Vd after the charging of the video signal Vp.

As shown in FIG. 3, for example, in the n-th frame, after the charging of the reverse transition prevention signal, the voltage Vcs1 that is applied to the first storage capacitance line CLA is varied by ΔVcs1 (ΔVcs1>0), and the voltage Vcs2 that is applied to the second storage capacitance line CLB is varied by ΔVcs2 (ΔVcs2>0).

After the charging of the video signal, the voltage Vcs1 that is applied to the first storage capacitance line CLA is varied by ΔVcs1 (ΔVcs1>0), and the voltage Vcs2 that is applied to the second storage capacitance line CLB is not varied (ΔVcs2=0).

As shown in FIG. 3, after the charging of the reverse transition prevention signal, ΔVcs1>0, and ΔVcs2>0. After the charging of the video signal, ΔVcs1>0, and ΔVcs2=0. Thereby, a liquid crystal voltage Vd0 after the charging of the reverse transition prevention signal can be made greater than a liquid crystal voltage Vd1 after the charging of the video signal.

In this manner, a variation amount ΔVd0 of the liquid crystal voltage Vd after the charging of the reverse transition prevention signal is made greater than a variation amount ΔVd1 of the liquid crystal voltage Vd after the charging of the video signal, and only the voltage, which is applied to the liquid crystal layer 3 in order to prevent reverse transition, can be increased. Therefore, the display period of the reverse transition prevention signal for preventing the reverse transition of the OCB mode liquid crystal can be shortened without affecting the display quality.

According to the above-described embodiment of the liquid crystal display device and the driving method thereof, it is thus possible to provide a liquid crystal display device with a higher brightness and a method of driving the liquid crystal display device.

As has been described above, a decrease in contrast occurs if a voltage higher than a voltage Vb corresponding to black display, which is shown in FIG. 4, is applied as the liquid crystal voltage Vd after the charging of the reverse transition prevention signal. Thus, in the case where the voltage higher than the voltage Vb corresponding to black display is applied to the liquid crystal layer 3 as the reverse transition prevention signal Vb by driving the liquid crystal display device in the above-described manner, the decrease in contrast can be prevented if the backlight is controlled in such a manner that the backlight is turned off during the period in which the reverse transition prevention signal Vb is applied and retained in the liquid crystal layer 3.

Specifically, according to the above-described embodiment of the liquid crystal display device and the driving method thereof, it is possible to provide a liquid crystal display device which can prevent a decrease in contrast and luminance and has a high display quality, and a method of driving the liquid crystal display device.

Next, a liquid crystal display device according to a second embodiment of the present invention is described. In the description below, the structural parts common to those of the liquid crystal display device according to the first embodiment are denoted by like reference numerals and a description thereof is omitted.

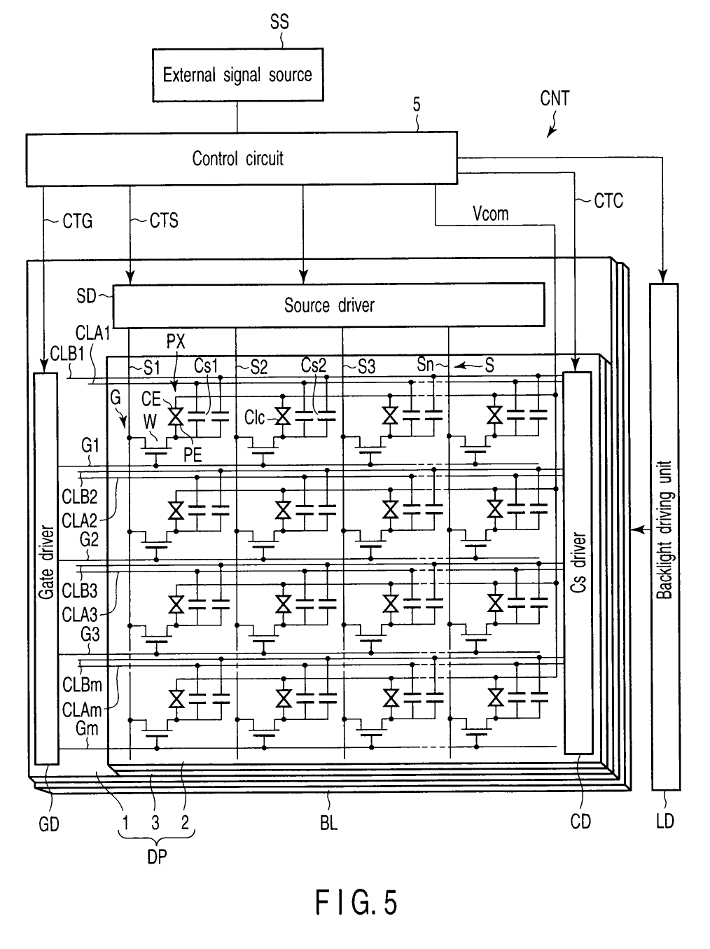

As shown in FIG. 5, a controller CNT of the liquid crystal display device according to the present embodiment includes, as driving units, a source driver SD to which signal lines S are connected; a gate driver GD to which scanning lines G are connected; a Cs driver CD to which first storage capacitance lines CLA and second capacitance lines CLB are connected; a backlight driving unit LD which drives the backlight BL; and a control circuit 5 which controls the gate driver GD, source driver SD, Cs driver CD and backlight driving unit (inverter) LD.

The gate driver GD successively drives the scanning lines G1 to Gm so as to turn on plural pixel switches W on a row-by-row basis. The source driver SD outputs source signals Vs to the plural signal lines S1 to Sn in a time period in which the pixel switches W of each row are turned on by the driving of the associated scanning line G. The Cs driver CD successively drives plural first storage capacitance lines CLA and second storage capacitance lines CLB so that the voltages of the first storage capacitance Cs1 and second storage capacitance Cs2 may vary on a row-by-row basis.

The control circuit 5 is configured to execute an initializing process for transitioning liquid crystal molecules from a splay alignment to a bend alignment by varying a counter-voltage Vcom at a time of power-on and applying a relatively high driving voltage to the liquid crystal layer 3.

The control circuit 5 outputs to the gate driver GD a control signal CTG which is generated on the basis of a sync signal that is input from the external signal source SS. The control circuit 5 also outputs a control signal CTC to the Cs driver CD, and outputs to the source driver SD a control signal CTS which is generated on the basis of the sync signal that is input from the external signal source SS, and a video signal Vp or a reverse transition prevention voltage Vb, which is input from the external signal source SS. Specifically, the control signal CTG of the liquid crystal display device in the above-described first embodiment is composed of the control signal CTG and control signal CTC which are output from the control circuit 5 of the liquid crystal display device according to the present embodiment. Further, the control circuit 5 outputs a counter-voltage Vcom, which is to be applied to the counter-electrode CE, to the counter-electrode CE of the counter-substrate CT.

As has been described above, the liquid crystal display device according to the present embodiment and the method of driving the liquid crystal display device are the same as the liquid crystal display device according to the above-described first embodiment and the method of driving the liquid crystal display device, except that the first storage capacitance Cs1 and second storage capacitance Cs2 are driven by the Cs driver CD.

Specifically, in the liquid crystal display device according to the present embodiment, the reverse transition prevention signal Vb or the video signal Vp is written in the pixel electrode PE, and after the pixel switch W is turned off, the potentials of the first storage capacitance line CLA and second storage capacitance line CLB are varied.

Like the case of the liquid crystal display device of the above-described first embodiment, the control circuit 5 controls the Cs driver CD to vary storage capacitance voltages Vcs1 and Vcs2 which are applied to the first storage capacitance Cs1 and second storage capacitance Cs2, thereby varying the magnitude of the liquid crystal voltage Vd after the charging of the reverse transition prevention signal Vb and the magnitude of the liquid crystal voltage Vd after the charging of the video signal Vp.

The variation amount ΔVd0 of the liquid crystal voltage Vd after the charging of the reverse transition prevention signal is made greater than the variation amount ΔVd1 of the liquid crystal voltage Vd after the charging of the video signal, and only the voltage, which is applied to the liquid crystal layer 3 in order to prevent reverse transition, can be increased. Therefore, the display period of the reverse transition prevention signal for preventing the reverse transition of the OCB mode liquid crystal can be shortened without affecting the display quality.

According to the above-described embodiment of the liquid crystal display device and the driving method thereof, it is thus possible to provide, like the first embodiment, a liquid crystal display device which can prevent a decrease in contrast and luminance and has a high display quality, and a method of driving the liquid crystal display device.

The present invention is not limited directly to the above-described embodiments. In practice, the structural elements can be modified without departing from the spirit of the invention.

For example, in the liquid crystal display device according to the above-described embodiments, the voltage Vcs2, which is applied to the second storage capacitance line CLB, is not varied after the charging of the video signal. However, this voltage Vcs2 may be varied within such a range that the variation of the voltage Vcs2 is necessary in order to improve the display quality. Even in such a case, the same advantageous effects as with the liquid crystal display devices of the above-described embodiments can be obtained by setting the variation amount ΔVd0 of the liquid crystal voltage Vd after the charging of the reverse transition prevention signal to be greater than the variation amount ΔVd1 of the liquid crystal voltage Vd after the charging of the video signal.

Various inventions can be made by properly combining the structural elements disclosed in the embodiments. For example, some structural elements may be omitted from all the structural elements disclosed in the embodiments. Furthermore, structural elements in different embodiments may properly be combined.

In the liquid crystal display devices according to the above-described embodiments, each of the display pixels PX is provided with the first storage capacitance Cs1 and second storage capacitance Cs2. Alternatively, each of the display pixels PX may be provided with one storage capacitance or three or more storage capacitances. Even in such a case, too, the same advantageous effects as with the liquid crystal display devices of the above-described embodiments can be obtained by setting the variation amount ΔVd0 of the liquid crystal voltage Vd after the charging of the reverse transition prevention signal to be greater than the variation amount ΔVd1 of the liquid crystal voltage Vd after the charging of the video signal.

What is claimed is:

1. A liquid crystal display device comprising:
a first substrate and a second substrate which are opposed to each other;
a liquid crystal layer which includes an OCB mode liquid crystal and is held between the first substrate and the second substrate;
a display section which is composed of a plurality of display pixels that are arrayed in a matrix; and
a driving unit which cyclically charges a reverse transition prevention signal and a video signal in each of the display pixels,
wherein the driving unit includes means for varying a liquid crystal voltage which is retained in the display pixel after the charging of the reverse transition prevention signal, and a liquid crystal voltage which is retained in the display pixel after the charging of the video signal, thereby making a variation amount of the liquid crystal voltage after the charging of the reverse transition prevention signal greater than a variation amount of the liquid crystal voltage after the charging of the video signal.

2. The liquid crystal display device according to claim 1, further comprising:
a pixel electrode which is disposed on the first substrate in association with each of the display pixels;
a counter-electrode which is disposed on the second substrate such that the counter-electrode is opposed to the plurality of pixel electrodes; and
a storage capacitance which is coupled to a liquid crystal capacitance which occurs between the pixel electrode and the counter-electrode,
wherein the driving unit includes means for making a variation amount of a storage capacitance voltage, which is applied to the storage capacitance after the charging of the reverse transition prevention signal greater than a variation amount of a storage capacitance voltage which is applied to the storage capacitance after the charging of the video signal.

3. The liquid crystal display device according to claim 2, wherein the first substrate further includes a storage capacitance line which is electrically connected to the storage capacitance, and
the driving unit includes means for making a variation amount of a voltage, which is applied to the storage capacitance line after the charging of the reverse transition prevention signal greater than a variation amount of a voltage which is applied to the storage capacitance line after the charging of the video signal.

4. The liquid crystal display device according to claim 1, further comprising:
a pixel electrode which is disposed on the first substrate in association with each of the display pixels;
a counter-electrode which is disposed on the second substrate such that the counter-electrode is opposed to the plurality of pixel electrodes;
a first storage capacitance and a second storage capacitance which are coupled to a liquid crystal capacitance which occurs between the pixel electrode and the counter-electrode;
a first storage capacitance line which is electrically connected to the first storage capacitance; and
a second storage capacitance line which is electrically connected to the second storage capacitance;
wherein the driving unit includes means for making storage capacitance voltages, which are applied to the first storage capacitance and the second storage capacitance after the charging of the reverse transition prevention signal greater than storage capacitance voltages, which are applied to the first storage capacitance and the second storage capacitance after the charging of the video signal.

5. A method of driving a liquid crystal display device comprising:
a first substrate and a second substrate which are opposed to each other;
a liquid crystal layer which is held between the first substrate and the second substrate and includes an OCB mode liquid crystal;
a display section which is composed of a plurality of display pixels that are arrayed in a matrix; and
a driving unit which cyclically applies a reverse transition prevention signal and a video signal to each of the plurality of display pixels,
the method comprising:
a step of cyclically charging the reverse transition prevention signal and the video signal in each of the plurality of display pixels; and
a step of varying a liquid crystal voltage which is retained in the display pixel after the charging of the reverse transition prevention signal, and a liquid crystal voltage which is retained in the display pixel after the charging of the video signal, and making a variation amount of the liquid crystal voltage after the charging of the reverse transition prevention signal greater than a variation amount of the liquid crystal voltage after the charging of the video signal.
